(19) United States
(12) Patent Application Publication
(10) Pub. No.: US 2007/0260009 A1
(43) Pub. Date: Nov. 8, 2007

(54) Block copolymer preparation method, block copolymers thus obtained and use thereof as compatibilizers

(76) Inventors: Jean-Francois Carpentier, Acigne (FR); Jerome Gromada, Lille (FR); Frederic Leising, Avilly-Saint-Leonard (FR); Andre Mortreux, Hem (FR)

Correspondence Address: Jean-Louis Seugnet;INTELLECTUAL PROPERTY DEPT., RHODIA INC., 259 PROSPECT PLAINS RAOD, CN 7500, CRANBURY, NJ, 08512-7500, US

(21) Appl. No.: 11/818,644

(22) Filed: Jun. 15, 2007

Related U.S. Application Data
(63) Continuation of application No. 10/477,572, filed on Apr. 7, 2004.

(30) Foreign Application Priority Data
May 18, 2001 (FR) 01/06600

(51) Int. Cl. C08G 73/02

(52) U.S. Cl. 524/571; 525/185

(57) ABSTRACT

The invention relates to a method of preparing a block copolymer, the first block of which is a polymer or a copolymer having at least one diene and the second block of which is a polymer with a polar monomer. The inventive method is characterised in that: first, the polymerisation or the copolymerisation of the first block is carried out in the presence of a catalyst comprising the product of the reaction of a rare earth alcoholate and an alkylating agent selected from among organolithiums, organomagnesiums, organozincs, organoaluminiums and borons; and, secondly, the copolymerisation of the polar monomer is performed with the first block in the presence of the same catalyst. The invention also relates to a block copolymer consisting of a first block comprising a polymer or a linear copolymer having at least one diene and a second block comprising a polymer presenting several hydroxy, epoxy and/or alkoxysilyl functions. Said copolymers can be used as compatibilisers in an elastomer matrix comprising a mineral filler.

The present invention relates to a method of preparing block copolymers and to certain block copolymers thus obtained.

The compatibilization of elastomers of the rubber or SBR (styrene-butadiene rubber) type with mineral fillers such as silica is of great interest for the tire industry. These mineral fillers do in fact make it possible to improve considerably the mechanical resistance and abrasion resistance of the tires. However, the combining of elastomers and mineral fillers remains problematic given the great differences in kind and in physicochemical properties between these two constituents. Attempts are therefore being made to develop new agents allowing the durable compatibilization of these two constituents. One particularly interesting way in this field consists in preparing diblock copolymers each of whose blocks allows the formation of covalent bonds with the elastomer on the one hand and with the mineral filler on the other. The formation of covalent bonds ensures maximum efficacy in the combining of these two constituents of the tire.

Accordingly, polydienes having a terminal epoxy function are known which allow the formation of an ether bond by opening of the epoxy ring by a hydroxyl function on the surface of the silica. These polymers, however, generally possess only a single epoxy function, and the attachment of the mineral filler to the compatibilizer is therefore only possible by a single covalent bond, which limits its efficacy, in particular over time. Additionally, in the case of the preparation of polymers based on polybutadiene, their preparation involves the anionic polymerization of butadiene, which is not very advantageous from an industrial standpoint, owing to the low temperatures required (typically −78° C.); moreover, the anionic polymerization of 1,3-butadiene produces a majority of poly(1,2-butadiene) and little poly(1,4-trans-butadiene), in other words proportions which are very different from those of the elastomer into which the mineral filler will be introduced, thereby limiting the efficacy of these functional polydienes as compatibilizers.

The object of the invention is the development of a method which allows copolymers of improved efficacy to be obtained and which, optionally, can be used under more favorable industrial conditions.

Another object of the invention is to provide block copolymers one of whose blocks is linear and another of whose blocks has a number of functionalities.

With this aim, the method according to the invention for preparing a block copolymer comprising a first block consisting of a polymer or copolymer of at least one diene and a second block consisting of a polymer of a polar monomer is characterized in that, in a first step, the polymerization or copolymerization of the first block is carried out in the presence of a catalyst which comprises a compound consisting of the reaction product of a rare earth alkoxide and an alkylating agent selected from organolithium, organomagnesium, organozinc, organoaluminum and boron compounds and then, in a second step, the copolymerization of the polar monomer with the first block is carried out in the presence of a catalyst of the same type.

The invention also pertains to a block copolymer comprising a first block consisting of a linear polymer or copolymer of at least one diene and a second block consisting of a polymer having two or more hydroxyl, epoxy and/or alkoxysilyl functions.

The method of the invention presents a number of advantages. It makes it possible to prepare copolymers having two or more functional units (hydroxyl, epoxy, alkoxysilyl), which allows the formation of a number of covalent bonds between the mineral filler and the copolymer and therefore ensures improved efficacy of the compatibilizer. It also makes it possible to prepare, effectively, by virtue of the rare-earth-based catalyst system, particularly block copolymers whose polybutadiene or poly(butadiene-stat-styrene) block possesses a very high poly(1,4-trans-butadiene) content. A third advantage of the method is that it allows the preparation of these block copolymers under conditions which are industrially advantageous, which do not involve very low temperatures.

Other features, details, and advantages of the invention will appear even more completely from the reading of the description which will now follow, and of the various specific but nonlimiting examples whose purpose is to illustrate said invention.

For the entirety of the description the term rare earth (RE) refers to elements from the group consisting of yttrium and the elements from the periodic classification whose atomic number is between 57 and 71 inclusive.

Furthermore, the term catalyst must be understood within the widest sense, i.e., as covering a product which is capable of having a catalyst function or else a reaction initiator function, particularly as a polymerization initiator.

As indicated earlier on above, the method of the invention relates to the preparation of a block copolymer. This copolymer comprises a first block consisting of a polymer of a diene or of a copolymer of different dienes.

The diene may in particular be a 1,3-diene, more particularly 1,3-butadiene (denoted by BD hereinafter), isoprene, and chloroprene. 1,3-butadiene is preferred.

The first block may also consist of a copolymer of a diene, of the type described earlier on above in particular, and at least one other monomer such as styrene or acrylonitrile. The method of the invention applies more particularly to the preparation of a block copolymer for which the first block is a butadiene-styrene copolymer.

The second block of the copolymer consists of a polymer of a polar monomer. This polar monomer may be, for example, a vinyl ester, a (meth)acrylic ester such as methyl acrylate or methyl methacrylate; it may be an epoxide such as ethylene oxide or a lactone.

The polar monomer, such as the vinyl ester or (meth)acrylic ester mentioned above, may include at least one hydroxyl, epoxy or alkoxysilyl function, more particularly a trialkoxysilyl function. Accordingly the polar monomer may be vinyltrimethoxysilane H₂C═CH—Si (OCH₃)₃; glycidyl (meth) acrylate CH₂═CRCO₂CH₂CH(0)CH₂ (hereinafter denoted by GMA), and trimethoxysilylpropyl methacrylate CH₂═CRCO₂(CH₂)₃Si(OMe)₃, R being H or CH₃.

The method of the invention employs a specific catalyst, which will now be described in more detail.

As indicated earlier on above, this catalyst comprises a compound consisting of the product obtained by the contacting or reaction of a rare earth alkoxide and an alkylating agent.

By alkoxide is meant the products corresponding to the general formula (1) (RE)ₓ(OR¹)_{y}(X)_{z}(S)ₜ in which R¹ denotes an organic group, which may be partly fluorinated or perfluorinated, X denotes any ligand other than an alkoxide which is capable of forming at least one covalent bond with the rare earth, such as, for example, a halogen, a nitrate, a carboxylate, an amide, a group of π-allyl type, a triflate, a thiolate, and S denotes a coordinating molecule such as a solvent, an amine, an alcohol, a phosphine or a thiol, and where x≧1, y≧1, z≧0 and t≧0. The term alkoxide also applies here to the alkoxides of formula (1) which comprise two or more different radicals R¹. The rare earth of the alkoxide is preferably neodymium or samarium.

The alkoxide may more particularly be an alkoxide of an alcohol or of a polyol derived from an aliphatic or cyclic hydrocarbon and in particular from a C₁-C₁₀, more particularly C₄-C₈, linear or branched aliphatic hydrocarbon. Mention may be made more particularly of tertiary alkoxides or polyalkoxides, for example, tert-butylate or tert-amylate.

The alkoxide may also be a phenoxide, in other words a derivative of a compound of phenolic or polyphenolic type. The alkoxide or phenoxide may be partly fluorinated or perfluorinated. Mention may be made in particular of the rare earth phenoxides of general formula RE(OAr)₃. (S)ₜ, where Ar is an aryl group substituted by sterically hindering groups, in particular disubstituted in the 2,6 positions, such as the tert-butyl or isopropyl group. Mention may be made more specifically of the following rare earth phenoxides, without any intention that this list should be limitative: Nd(OC₆H₃-2,6-tBU₂)₃, Nd(OC₆H₂-2,6-tBU₂-4-Me)₃, Nd(OC₆H₂-2,4,6-tBu₃)₃.

The alkoxide may also be a carboxylate, in other words a product of formula (1) above in which the group OR¹ is an acidic group O—C(O)—R¹, R¹ being an alkyl or phenyl radical. The carboxylates are generally prepared by reacting a rare earth salt with a carboxylic acid. This acid may in particular be an aliphatic, cycloaliphatic or aromatic acid which is saturated or unsaturated and has a linear or branched chain. It is preferred to use carboxylates having at least 6 carbon atoms, more particularly those which are C₆-C₃₂ and more particularly still those which are C₆ to C₁₈. By way of examples, mention may be made, as carboxylates, of isopentanoate, hexanoate, 2-ethylhexanoate, 2-ethylbutyrate, nonanoate, isononanoate, decanoate, octanoate, isooctanoate, neodecanoate, undecylenate, laurate, palmitate, stearate, oleate, linoleate and naphthenates. Very particularly it is possible to use the salt of neodecanoic acid. This is understood as reference to mixtures of branched carboxylic acids having generally approximately 10 carbon atoms and an acid number of approximately 310 to approximately 325 mg KOH/g, which are sold by Shell under the brand name “Versatic 10” (generally referred to as versatic acid) or by Exxon under the brand name “Neodecanoic acid”. As carboxylates which can be used in the method of the invention mention may be made in particular of those described in patent applications WO 98/39283, WO 99/54335, and WO 99/62913 and patent U.S. Pat. No. 5,783,676.

The alkoxide is preferably prepared by specific methods, which will be described in more detail hereinbelow.

A first method employs the reaction of a rare earth halide with an alkali metal or alkaline earth metal alkoxide. The halide may more particularly be a chloride and the alkali metal may in particular be sodium and potassium.

The reaction takes place in an anhydrous solvent medium in the absence of air. The solvent medium consists of tetrahydrofuran (THF) or comprises tetrahydrofuran in a mixture with another solvent. As the other solvent mention may be made of liquid aliphatic hydrocarbons of 3 to 12 carbon atoms such as heptane, cyclohexane, alicyclic or aromatic hydrocarbons such as benzene, toluene or else the xylenes. Mention may also be made of ethers.

The reaction takes place generally at a temperature which can be between ambient (20° C.) and 100° C. for a period which may vary between approximately 12 hours and approximately 96 hours. In the case of the preparation of a phenoxide the reaction mixture is taken to reflux over a period of the same order of magnitude.

At the end of the reaction the reaction medium is decanted and the supernatant is recovered and evaporated. This gives a solid product in powder form which constitutes the rare earth alkoxide.

A second, specific method of preparing the alkoxide consists in reacting an alkali metal or alkaline earth metal alkoxide with an adduct of a rare earth halide and THF (REX₃,xTHF) . The comments made earlier on above with regard to the nature of the alkoxide and of the halide apply here as well. The adduct is obtainable by heating a rare earth halide in THF, at 50° C. for example, decanting the reaction mixture, filtering the product and then evaporating the solvent. This evaporation can be done under vacuum at 20° C. The reaction with the alkoxide also takes place in an anhydrous solvent medium in the absence of air, and under the same conditions as those described for the preceding method. The solvents are of the same type as those given precedingly and mention may be made in particular of toluene.

A third specific method of preparing the alkoxide may be mentioned. This method consists in reacting an alcohol with a rare earth amide. The alcohol may be an alcohol, a polyol or a compound of phenolic or polyphenolic type such as those defined earlier on above. The amide is a compound of formula RE(N(SiR²₃)₂)₃, it being possible for the radicals R² to be identical or different and to denote in particular a hydrogen or a linear or branched alkyl radical, methyl for example. The reaction takes place again in an anhydrous solvent medium and in the absence of air. The solvent medium consists of tetrahydrofuran (THF) or comprises tetrahydrofuran in a mixture with another solvent. As the other solvent mention may be made of liquid hydrocarbons of 3 to 12 carbon atoms such as heptane, cyclohexane, cyclic or aromatic hydrocarbons such as benzene, toluene or else the xylenes. Mention may also be made of ethers. The reaction temperature may be between −80° C. and 100° C., but it is general practice to work at ambient temperature. The duration of the reaction may vary between 15 minutes and 96 hours, and can for example be 24 hours.

Finally, a last specific method for preparing the alkoxide may be described. It consists in reacting an alcohol as defined above with an adduct of a rare earth amide as defined above and THF. This adduct can be prepared in the same way as that indicated for the adduct described precedingly. The remainder of the method is also the same type as described above for the amide.

The second compound involved in the reaction with the rare earth alkoxide is an alkylating agent.

This alkylating agent is selected from organolithium compounds R³Li, organozinc compounds ZnR³₂, organoaluminum compounds AlR³₃₋ₙXₙ, and boron compounds BR³₃.

In these formulae R³ denotes an alkyl radical, in particular a C₁-C₁₈ radical, more particularly a C₁-C₈ radical, which is linear or branched. R³ may more particularly be n-hexyl. The radical R³ may also carry a heteroatom such as Si. Mention may be made in particular of the radical —CH₂—Si(CH₃)₃. X denotes a halogen, which can be bromine, chlorine or iodine, although bromine is used more particularly, and n is 0, 1, 2 or 3.

The alkylating agent may also be selected from organomagnesium compounds.

An organomagnesium compound means a product which is either a dialkylmagnesium compound or a Grignard reagent.

In the case of a dialkylmagnesium compound, i.e., the compounds of formula (2) R⁴—Mg—R^{4′}, where R⁴ and R^{4′} denote alkyl radicals of the same type as R³. R⁴ and R^{4′} can more particularly be n-hexyl. Mention may also be made more particularly of the product of formula (2) in which R⁴ and R^{4′} are, respectively, butyl and ethyl. The alkyl radicals R⁴ and/or R^{4′} may also carry a heteroatom such as Si and may in particular represent the radical —CH₂—Si(CH₃)₃.

The organomagnesium compound may also be a Grignard reagent, in other words a compound of formula (3) R⁵—Mg—X where X denotes a halogen; the halogen may be bromine, chlorine or iodine, although the compounds used are more particularly those for which the halogen is bromine. The nature of R⁵ is arbitrary. R⁵ can in particular be a saturated or unsaturated aliphatic or an alicyclic or aromatic radical. R⁵ may more particularly be an alkyl radical, such as the ethyl radical, or else a phenyl radical.

The organomagnesium compound may also be a mixed compound of formula (4) R⁶—Mg—OR⁶, where R⁶ and R⁶, which are identical or different, may be saturated or unsaturated aliphatic or alicyclic or aromatic radicals. R⁶ and R⁶ may more particularly be alkyl radicals, such as the ethyl radical, or else phenyl radicals.

The rare earth alkoxide and the alkylating agent may be contacted or reacted in variable respective proportions. This proportion may be expressed by the ratio M/RE, M denoting Li, Zn, Al, B or Mg. This ratio (molar ratio) is generally between 0.5 and 10, preferably between 1 and 4. It would not, however, be to depart from the scope of the present invention to use a ratio outside the aforementioned range. This ratio may vary in particular as a function of the rare earth alkoxide used and of the compounds which it is intended to polymerize.

The product of the reaction of the rare earth alkoxide and the alkylating agent is commonly in the form of a solution, which is obtained generally by mixing and then reacting a first solution of the alkoxide with a second solution of the alkylating agent, followed by stirring. These solutions are in solvents of the same type as those mentioned earlier on above, namely in particular C₄-C₁₈ aliphatic hydrocarbons and aromatic hydrocarbons. The mixture obtained from the two aforementioned solutions may be held and stirred, prior to its use, at a temperature which may be between −50° C. and the ambient temperature, for a duration of from several minutes to several hours, for example, for one hour.

The product of the reaction of the rare earth alkoxide and the alkylating agent will be used in the method of preparing block copolymers by contacting it, in a first step, with the diene or dienes or else with the mixture of the diene and the other monomer, the styrene or acrylonitrile in particular.

Generally this reaction takes place in a solvent medium. This solvent may in particular be a hydrocarbon. It is possible in particular to use liquid aliphatic hydrocarbons such as, preferably, hexane, heptane or aromatic hydrocarbons such as benzene, toluene. The reaction takes place under the known conditions. The reaction takes place commonly at a temperature of between −40° C. and 100° C., advantageously between 0° C. and 60° C., and more particularly still at ambient temperature (approximately 20° C.-25° C.), in an atmosphere containing neither water nor oxygen. The reaction is generally performed in a closed reactor in order to contain the increase in pressure due to the evaporation of the diene at the time of the increase in temperature following its condensation in the reactor.

This first step of the method, which consists in polymerizing the diene or in copolymerizing the diene with another monomer, takes place over a reaction time ranging from 15 min to 24 h, depending on the temperature and the nature and amount of the rare earth salt used.

The second step of the method consists in copolymerizing the polar monomer with the first block. This second step can be carried out by introducing the polar monomer into the reaction medium obtained at the outcome of the first step.

The addition of the polar monomer to this reaction medium is made at a low temperature, typically at −30° C. Once this addition has been carried out the reaction medium is stirred, under the atmospheric pressure of an inert gas, at a temperature of between −30° C. and +50° C., more particularly between 0° C. and 20° C., for a variable period ranging from 1 to several hours. The polymerization reaction is stopped by adding to the reaction medium a protic derivative, which may be a small amount of methanol or water. The preferred procedure is to add a very slightly aqueous solution of THF, containing from 5 to 50 equivalents of water per rare earth atom, typically 20 equivalents.

The final copolymer is recovered by evaporating the solution, extracting the residue with THF, and then evaporating the extract.

The invention also relates to certain block copolymers, which will now be described in more detail.

As indicated earlier on above the block copolymers of the invention comprise a first block consisting of a linear polymer or copolymer of at least one diene and a second block consisting of a polymer having two or more hydroxyl, epoxy or alkoxysilyl functions. The description given earlier on above with regard to the first block in the description of the method applies here as well, on the understanding that the feature of the first block of the copolymers of the invention is the linearity.

In the case of the block copolymers of the invention whose first block consists of a polymer of 1,3-butadiene or of a copolymer thereof with another monomer such as styrene or acrylonitrile, in particular, these copolymers may present the additional feature of having a poly(1,4-trans-butadiene) content of at least 95% for the first block.

It will be noted, moreover, that the invention also applies to a method allowing the preparation of a copolymer having three blocks, the third block being a polymer or a copolymer of a diene. In this case the method comprises a third step in which said diene is polymerized in the additional presence of a catalyst of the same type as that used in the preceding steps. Consequently the invention also covers a copolymer comprising three blocks, namely a first block consisting of a linear polymer or copolymer of at least one diene, a second block consisting of a polymer having two or more hydroxyl, epoxy and/or alkoxysilyl functions, and a third block consisting of a polymer or copolymer of a diene, it being possible for the polymer or copolymer of this third block to be linear. The description given earlier on above with regard to the first and second block also applies here to the definition of this latter triblock copolymer.

The present invention finally relates to the use as compatibilizer, in an elastomeric matrix comprising a mineral filler, of a copolymer obtained by the method described earlier on above or of a copolymer having the features which have just been given above. This use is appropriate more particularly in the case of an elastomeric matrix wherein the mineral filler is silica. The elastomer of the matrix may in particular be of the rubber, SBR or NBR (nitrile-butadiene rubber) type.

Examples will now be given which relate to the preparation of diblock poly(butadiene-co-glycidyl methacrylate) copolymers.

### EXAMPLE 1

A solution of Nd(OC₆H₂-2,6-tBu₂-4-Me)₃ (400 mg, 0.5 mmol, prepared beforehand by ionic metathesis between NdCl₃ and Na[OC₆H₂-2,6-tBu₂-4-Me] in THF) in hexane (12.5 mL) is admixed at 0° C. with a solution of Mg(n-hexyl)₂ (980 mg of a 20% by mass solution in heptane, 1.0 mmol; Mg/Nd=2) in hexane (12.5 mL). The reaction mixture is stirred magnetically at 0° C. for 1 h. Butadiene (8.5 mL, 100 mmol) is added at −30° C. to this solution using a cannula. The solution is stirred magnetically at ambient temperature for 2 h. The reaction mixture is then cooled to 0° C. and GMA (2.0 mL, 15 mmol) is added by syringe over 5 seconds. The reaction mixture is stirred magnetically at ambient temperature for 3 h. The polymerization is stopped by adding aqueous THF (20 mL of THF containing 0.2 mL of water). The mixture is stirred magnetically for 1 h. Evaporation to dryness under vacuum at ambient temperature gives a white powder (4.0 g). This crude powder is taken up in 100 mL of THF and the suspension is stirred magnetically for 1 h and then filtered over celite in order to remove the insoluble residues. Following evaporation of the solvent under vacuum at ambient temperature a white powder is recovered (m=3.6 g, yield=47% relative to the masses of the monomers introduced initially). This powder is soluble in chlorinated solvents such as chloroform and in THF, and is relatively insoluble in pentane. The small amount of residual GMA monomer is removed by washing the white powder with a minimal amount of pentane, followed by drying under vacuum.

Analysis of the final copolymer by ¹H NMR in CDCl₃ showed that the BD/GMA ratio was 5.8 and that the polybutadiene block consisted of more than 95% of poly(1,4-trans-butadiene). These results are corroborated by ¹³C NMR analysis. Analysis of the copolymer by gel permeation chromatography (THF, 20° C., Waters SIS HPLC pump, Waters 410 refractometer, Waters styragel HR2, HR3, HR4, and HR5E columns) indicates a monomodal distribution with a number-average molar mass Mₙ of 5500 and a polydispersity index M_{w}/Mₙ of 1.76. Infrared analysis of the copolymer (KBr disc) shows the characteristic bands of the poly(1,4-trans-butadiene) block at ν (cm⁻¹): 2957 (m), 2923 (s), 2906 (w), 2846 (s), 1640 (w), 1457 (s), 1447 (s), 966 (vs), 911, 774, and of the poly(GMA) block at v (cm⁻¹): 1733 (vs), 1260 (s), 1150 (vs, br), 849 (s). Analysis by DSC (Setaram DSC 141, 10° C./min, under nitrogen) shows an endothermic peak (melting) of between 33 and 65° C., which is centered at 50° C.

### EXAMPLE 2

The procedure of Example 1 was repeated, but using 1.0 mol equivalent (or 0.5 mmol) of Mg(n-hexyl)₂ relative to the Nd. 4.0 g of crude product were recovered, which led, following complete treatment, to 3.0 g (yield=41%) of a white powder which is soluble in CHCl₃ and in THF. Analysis of this solid by ¹H NMR in CDCl₃ revealed that the BD/GMA ratio was 35 and that the polybutadiene block consisted of more than 95% of poly(1,4-trans-butadiene). Analysis of the copolymer by GPC indicates a monomodal distribution with a number-average molar mass Mₙ of 6350 and a polydispersity index M_{w}/Mₙ of 1.2.

### EXAMPLE 3

The procedure of Example 1 was repeated, but using 10 mol equivalent (or 5 mmol) of Mg(n-hexyl)₂ relative to the Nd. 3.8 g of crude product were recovered, which led, following complete treatment, to 2.4 g (yield=33%) of a white powder which is soluble in CHCl₃ and in THF. Analysis of this solid by ¹H NMR in CDCl₃ revealed that the BD/GMA ratio was 0.36 and that the polybutadiene block consisted of more than 95% of poly(1,4-trans-butadiene). Analysis of the copolymer by GPC indicates a monomodal distribution with a number-average molar mass Mₙ of 1000 and a polydispersity index M_{w}/Mₙ of 1.4.

### EXAMPLE 4

The procedure of Example 1 was repeated, but using 1.0 mmol of n-BuLi (1.6 M solution in hexane) instead of Mg(n-hexyl)₂. The Li/Nd ratio was therefore 2.0. Analysis by GPC of a sample taken immediately prior to addition of the GMA revealed that the polybutadiene formed had a monomodal distribution with a number-average molar mass Mₙ of 5280 and a polydispersity index M_{w}/Mₙ of 1.35. Following reaction of the GMA, 3.9 g of crude product were recovered which led, following complete treatment as indicated in Example 1, to 1.5 g (yield=20%) of a yellow powder which was soluble in CHCl₃ and in THF. Analysis of this solid by ¹H NMR in CDCl₃ revealed that the BD/GMA ratio was 7 and that the polybutadiene block consisted of more than 95% of poly(1,4-trans-butadiene). Analysis of the copolymer by GPC indicates a poly(tri)modal distribution with a number-average molar mass Mₙ of 10,000 and a polydispersity index M_{w}/Mₙ of 2.67.

### EXAMPLE 5

The procedure of Example 1 was repeated, but using Nd₃(Ot-Bu)₉(TFH)₂ (396 mg, 1.0 mmol equiv. Nd; prepared beforehand by ionic metathesis between NdCl₃ and NaOt-Bu in THF) instead of Nd(OC₆H₂-2,6-tBu₂-4-Me)₃. The Mg/Nd ratio is therefore 1.0. The BD was polymerized at 60° C. for 18 h and the GMA was polymerized at 0° C. for 1.5 h. 3.5 g of crude product were recovered which led, following complete treatment, to 3.3 g (yield=43%) of a yellow solid which was soluble in CHCl₃ and in THF. Analysis of this solid by ¹H NMR in CDCl₃ revealed that the BD/GMA ratio was 1.8 and that the polybutadiene block consisted of more than 95% of poly(1,4-trans-butadiene). Analysis of the copolymer by GPC indicates a monomodal distribution with a number-average molar mass Mₙ of 23,800 and a polydispersity index M_{w}/Mₙ of 1.84.

1-16. (canceled)

17. A method of preparing a block copolymer comprising a first block being a polymer or copolymer of at least one diene which is 1,3-butadiene, isoprene or chloroprene and a second block being a polymer of a monomer which is vinyl ester, a (meth)acrylic ester, an epoxide or a lactone, said process comprising:
a first step a), wherein a polymerization or copolymerization of the diene, by which the first block is obtained, is carried out in the presence of a catalyst comprising a compound being the reaction product of a rare earth alkoxide and an alkylating agent which is organolithium, organomagnesium, organozinc, organoaluminum or boron compounds; and, then,
a second step b), wherein a copolymerization of said monomer with the first block is carried out in the presence of a catalyst of the same type.

18. The method of claim 17, wherein the first block of the block copolymer is a copolymer of a diene and styrene.

19. The method of claim 17, wherein the monomer comprises at least one hydroxyl, epoxy or alkoxysilyl function.

20. The method of claim 19, wherein the function is glycidyl methacrylate or trimethoxysilylpropyl methacrylate.

21. The method of claim 17, wherein the catalyst is prepared from a rare earth alkoxide which originates either from the reaction of a rare earth halide with an alkali metal or alkaline earth metal alkoxide in an anhydrous solvent being or comprising tetrahydrofuran or from the reaction of a rare earth amide with an alcohol in an anhydrous solvent comprising tetrahydrofuran.

22. The method of claim 21, wherein the catalyst is prepared a rare earth alkoxide which originates from the reaction in an anhydrous solvent either of an alkali metal or alkaline earth metal alkoxide with an adduct of a rare earth halide and tetrahydrofuran or of an alcohol with an adduct of a rare earth amide and tetrahydrofuran.

23. The method of claim 22, wherein the catalyst is prepared from a rare earth alkoxide which originates from a compound of phenolic or polyphenolic type or from an alcohol or polyol derived from a C₁-C₁₀, linear or branched aliphatic hydrocarbon.

24. The method of claim 17, wherein the rare earth is neodymium or samarium.

25. The method of claim 17, wherein the alkylating agent is made of an organomagnesium compound which is a dialkylmagnesium of formula R—Mg—R′ wherein R and R′ denote identical or different linear or branched alkyl radicals.

26. A block copolymer comprising a first block consisting of a linear polymer or copolymer of at least one diene and a second block consisting of a polymer having two or more hydroxyl, epoxy or alkoxysilyl functions.

27. The block copolymer of claim 26, wherein the first block consists of a polymer of 1,3-butadiene, isoprene or chloroprene.

28. The block copolymer of claim 27, wherein the first block consists of a copolymer of a diene and styrene.

29. The block copolymer of claim 27, wherein the first block consists of a polymer or copolymer of 1,3-butadiene having a poly(1,4-trans-butadiene) content of at least 95%.

30. A compatibilizer for an elastomeric matrix with a mineral filler, comprising the copolymer as defined in claim 26.

31. The compatibilizer of claim 30, wherein the mineral filler is silica.
